(19) United States
(12) Patent Application Publication
(10) Pub. No.: US 2026/0348274 A1
(43) Pub. Date: Nov. 5, 2026

(54) METHOD OF DRILLING A GEOLOGICAL FORMATION

(71) Applicant: PETRÓLEO BRASILEIRO S.A. - PETROBRAS, Rio de Janeiro (BR)

(72) Inventors: Angelo Marinho Vianna, Rio de Janeiro (BR); Jose Thomaz Goncalves, Macaé (BR); Walter Francisco Cardosa Junior, Rio de Janeiro (BR); Flavia Camanzi Cruz, Macaé (BR); Laura Correia Musgueira Geraci, Macaé (BR); Elessandre Alves De Souza, Rio de Janeiro (BR)

(21) Appl. No.: 19/661,859

(22) Filed: Apr. 29, 2026

(30) Foreign Application Priority Data
May 5, 2025 (BR) 1020250088770

(51) Int. Cl. E21B 49/00; C09K 8/08; C09K 8/12; E21B 21/06

(52) U.S. Cl. CPC E21B 49/003; C09K 8/08; C09K 8/12; E21B 21/062

(57) ABSTRACT

The present invention pertains to the field of soil or rock drilling for oil or gas extraction. It is a method of drilling a geological formation that enables the use of a single aqueous drilling fluid to drill through long stretches of shale followed by a reservoir of sandy composition. The method comprises monitoring fluid components—including solids content and clay inhibitor concentration—during drilling through the geological formation and controlling the replenishment of certain clay inhibitors in the drilling fluid, so that the initial drilling uses a fluid with high-performance characteristics and, as the drill bit approaches the sandy reservoir, the fluid assumes the characteristics of an inhibited drill-in fluid. Thus, the method of the invention ensures the stability necessary for drilling clayey rocks (i.e., shale), by applying a high-performance fluid (i.e., composed of physicochemical mechanisms for stabilizing clay particles), and the preservation of the integrity of the sandy reservoir, by depleting clay inhibitors that are harmful to the sandstone.

### RELATED APPLICATIONS

This application claims the benefit of priority to Brazilian Patent Application No. 1020250088770, filed May 5, 2025, the entire contents of which are incorporated herein by reference.

### FIELD OF THE INVENTION

The present invention pertains to the field of oil and gas well drilling engineering, more specifically to methods of operational control during well drilling in post-salt fields. In particular, the invention relates to a drilling method based on the monitoring and adjustment of components of a water-based drilling fluid.

### BACKGROUND OF THE INVENTION

The development of the TOT-3P design aimed to significantly reduce the total well construction time in the post-salt of the Campos and Espirito Santo Basins, resulting in significant savings for Petrobras. This configuration is characterized by drilling in three phases (3P—three phases), with only the third phase returning to the surface, and by the installation of the completion assembly, consisting of the production or injection string and sand containment screens, in a single operation (TOT—true one-trip).

Prior to the TOT-3P concept, the most optimized well configuration for post-salt wells in the Campos and Espirito Santo Basins up to 2020 was based on four phases, with phase 3 consisting mainly of clay formations and drilled with non-aqueous fluid, and phase 4 (phase of interest) consisting mainly of sandstone reservoir and drilled with aqueous drill-in fluid.

Wells that showed more significant shale intercalations in phase 4 underwent an adjustment in the drill-in fluid formulation, with the addition of clay inhibitors with low potential to cause formation damage, such as amphoteric polymers and glycols. This drill-in fluid with an optimized formulation came to be called inhibited drill-in fluid.

The TOT-3P configuration includes deepening the second-phase casing, which must withstand the stresses required throughout the life cycle of the well, as it will serve as both surface and production casing.

The final phase involves drilling a significant section of shale followed by a sandstone reservoir, requiring a drilling fluid capable of ensuring chemical inhibition for the clay formations, low damage potential for the sandstone formations, and compatibility with the type of completion and stimulation fluid needed for the project.

In the completion stage, the impacts are related to the selection of the fluid to be placed in the well at the end of drilling, in order to: (i) ensure mechanical stability during the removal of the BHA (bottom hole assembly) and the installation of the completion assembly, (ii) minimize damage to the sandstone reservoir, (iii) allow minimum injectivity for the acid treatment of the formation, and (iv) be compatible with the stimulation fluid.

In 2020, the first well in TOT-3P design, 7-GLF-49H-ESS, was drilled using a technical solution employing non-aqueous fluids in both the drilling and completion stages. However, the development of this solution was directed only towards production wells. The use of non-aqueous fluid, which contains organosoluble materials, for drilling injection wells would require pre-treatment prior to the acidification operation for wettability inversion, in order to allow acid attack on the particles. Additionally, there is no evidence of the efficiency of this type of pre-treatment in Petrobras wells.

Thus, prior to the invention, the execution of optimized configurations with a significant section of clay formations followed by a sandstone reservoir in the phase of interest was limited to the construction of production wells.

In this context, the object of this invention is the development of a drilling method that allows the construction of phases with an extensive shale section followed by a sandstone reservoir in both production and injection wells, ensuring the mechanical stability of the well during the drilling and descent stages of the one-trip or true-one-trip completion, in addition to minimal damage to the reservoir.

To this end, the invention contemplates the use of a high-performance aqueous drilling fluid for drilling the extensive shale section and the execution of a depletion strategy for damaging chemicals in the final portion of the section drilling. The objective of this strategy is for the fluid to approximate a drill-in inhibited fluid composition and be able to traverse the sandstone reservoir when its top is encountered.

The high-performance fluid shows several mechanisms for chemical and physical inhibition of clay formations. The use of this fluid aims to minimize well problems associated with drilling shale and marl, due to the rock-fluid interaction phenomenon. However, due to the high potential for damage to the sandstone formation showed by this fluid, its use is not recommended for drilling the sandstone reservoir.

The present invention solves the recognized limitation of using a single aqueous composition fluid to drill consecutive clayey and sandstone sections. Literature suggests that the composition of drilling fluids should be appropriate to the rock composition in order to avoid formation damage and risks to the well structure (ORUN, Cosmas B.; AKPABIO, Julius U.; AGWU, Okorie E. Drilling fluid design for depleted zone drilling: An integrated review of laboratory, field, modelling and cost studies. Geoenergy Science and Engineering, volume 226, page 211706, 2023; HALIM, Michael Chuks; HAMIDI, Hossein; AKISANYA, Alfred R. Minimizing formation damage in drilling operations: A critical point for optimizing productivity in sandstone reservoirs intercalated with clay. Energies, volume 15, number 1, page 162, 2021; MUHAMMED, Nasiru Salahu; OLAYIWOLA, Teslim; ELKATATNY, Salaheldin. A review on clay chemistry, characterization and characterization of shale inhibitors for water-based drilling fluids. Journal of Petroleum Science and Engineering, volume 206, page 109043, 2021).

For example, WO 2017147712 describes drilling fluid compositions comprising a formate salt and a silicate salt, which can be used as a shale stabilizing agent.

Alternatively to developing improved formulations with known components, substances with chemical behavior favorable to blocking particles that are harmful to well integrity are sought. For example, U.S. Ser. No. 10/442,973 describes a high-performance, superamphiphobic water-based drilling fluid. The property of the fluid is given by a copolymer formed by acrylamide-derived subunits linked to nano-titania.

Conversely, the inventors of the solution being described have demonstrated that it is possible to use a single water-based drilling fluid to drill through long stretches of shale followed by a sandstone reservoir simply by modulating the concentration and activity of the clay inhibitors used in the fluid composition. The drilling method detailed below comprises refined control of the fluid composition during well drilling, so as to ensure that there are no harmful components when the drill bit reaches the sandstone layer.

### SUMMARY OF THE INVENTION

The invention relates to a method for drilling a geological formation consisting of a shale section followed by a sandstone reservoir, comprising the use of a high-performance aqueous drilling fluid during drilling, wherein the method comprises:
a) periodically monitoring the concentration of clay inhibitors in the drilling fluid during drilling;
b) periodically monitoring the clay content dispersed in the drilling fluid during drilling; and
c) stopping the replenishment of clay inhibitors in the drilling fluid at a predetermined distance from the sandstone reservoir.

In one embodiment of the invention, the drilling fluid is a high-performance fluid composed of: sodium chloride brine, an encapsulating polymer, a cationic polymer, an amphoteric polymer, a polyol, potassium silicate, potassium chloride, HPA starch, xanthan gum, sodium bicarbonate, magnesium oxide, glutaraldehyde, antifoaming agent and limestone 2-44.

In a preferred embodiment, the encapsulating polymer that makes up the high-performance drilling fluid is a partially hydrolyzed polyacrylamide-based polymer of high molecular weight and anionic character. Also preferably, the cationic polymer is a quaternary ammonium salt or a polyelectrolyte based on low molecular weight polyamine. Furthermore, the amphoteric polymer is a low molecular weight amphoteric polymer with an isoelectric point below 7.0. Finally, the polyol is a high molecular weight non-ionic polymer based on polyols.

The invention includes the periodic monitoring of the concentration of clay inhibitors and the dispersed clay content in the drilling fluid and involves the collection of fluid samples during drilling. In a particular embodiment of the invention, samples of the drilling fluid are collected at regular intervals from about 25 m to about 500 m drilled. In a preferred embodiment, sampling occurs every 50 m drilled.

In certain embodiments of the invention, the replenishment of clay inhibitors in the drilling fluid is interrupted at a predetermined distance from the sandstone reservoir. In preferred embodiments, the replenishment of clay inhibitors in the drilling fluid is interrupted at least about 10 m, about 20 m, about 30 m, about 40 m, about 50 m, about 60 m, about 70 m, about 80 m, about 90 m, about 100 m, about 150 m, about 200 m, about 250 m, or about 300 m from the predicted depth to the top of the sandstone reservoir.

In a preferred embodiment, the replenishment of the encapsulating polymer and potassium silicate clay inhibitors in the drilling fluid is interrupted between 80 and 100 m from the predicted depth to the top of the sandstone reservoir. Even more preferably, the replenishment of clay inhibitors is stopped 100 m from the predicted depth to the top of the sandstone reservoir.

### BRIEF DESCRIPTION OF THE FIGURES

FIG. 1 illustrates the linear swelling of clay for high-performance fluid and drill-in fluid.

FIG. 2 demonstrates gravel with satisfactory chemical inhibition in the shale section, as evaluated in field testing.

FIG. 3 represents controlled dispersed clay values during drilling of the shale sections in 2 wells.

### DETAILED DESCRIPTION OF THE INVENTION

Unless otherwise specified, the terms used throughout this specification have their common meanings in the art, within the context of the disclosure, and in the specific context in which each term is used. Certain terms that are used to describe the disclosure are discussed below, or elsewhere in the specification, to provide additional guidance to the practitioner regarding the description of the disclosure. The publications being mentioned and the material to which they are mentioned are specifically incorporated by reference in their entirety.

It will be appreciated that the same thing can be said in different ways. Consequently, alternative language and synonyms may be used for any one or more of the terms being discussed. No special meaning should be admitted when a term is being elaborated or discussed.

The solution being proposed allows the application of a high-performance aqueous drilling fluid during drilling of both the clayey section and the sandstone phase. However, due to the high potential for formation damage shown by this fluid, its use is not recommended for drilling the sandstone reservoir.

In this context, the present invention represents a solution to simultaneously circumvent the hydration of clay particles in the shale layer and the presence of clay inhibitors in the drilling fluid used to drill the sandstone layer.

The invention contemplates the use of a high-performance aqueous drilling fluid for drilling the extensive shale section and the execution of a depletion strategy for damaging chemicals in the final portion of drilling the clay section (i.e., before reaching the sandstone reservoir). The objective of this strategy is for the fluid to approximate an inhibited drill-in fluid composition and be able to traverse the sandstone reservoir when its top is encountered.

As being used, the term “high-performance drilling fluid” denotes a water-based drilling fluid that is circulated between the drill bit and the wellbore wall to provide a higher rate of drill penetration, better wellbore stability control, and reduced circulation losses, environmental impact, and equipment wear.

In general, high-performance drilling fluids include viscosifying agents, filtrate control agents to reduce excessive fluid loss to the rock formation, density control agents to maintain controlled well pressure, emulsifiers and surfactants, lubricants, pH and alkalinity control agents, corrosion inhibitors, bactericides, and several chemical and physical inhibition mechanisms of clay formations.

In the context of the present invention, the high-performance drilling fluid is prepared on an aqueous basis and comprises a combination of clay inhibitors composed of sodium chloride brine, an encapsulating polymer, a cationic polymer, an amphoteric polymer, a polyol, potassium silicate, and potassium chloride. The drilling fluid formulation in the context of the invention further comprises HPA starch, xanthan gum, sodium bicarbonate, magnesium oxide, glutaraldehyde, antifoaming agent, and limestone 2-44.

In a preferred embodiment, the encapsulating polymer that composes the high-performance drilling fluid is a partially hydrolyzed polyacrylamide-based polymer of high molecular weight and anionic character. Those skilled in the art will recognize that the encapsulating polymer applicable to the invention may be a commercial product, such as, for example, EZ-MUD® (Halliburton), New9/21 Drill® (Baker Hughes), Hydracap® (SLB), Ultracap® (SLB) or IDCAP® (SLB).

Also preferably, the cationic polymer is a quaternary ammonium salt or a low molecular weight polyamine-based polyelectrolyte. Those skilled in the art will recognize that the cationic polymer applicable to the invention may be a commercial product, such as, for example, Clay Inhibitor 375® (Halliburton), Max-guard® (Baker Hughes), Klagard® (SLB), Kla-stop® (SLB) or Hiperm® (NewPark).

Furthermore, the amphoteric polymer is a low molecular weight amphoteric polymer with an isoelectric point below 7.0. A person skilled in the art will recognize that the amphoteric polymer applicable to the invention may be a commercial product, such as, for example, Clayseal® (Halliburton), BDF-995® (Halliburton), Kla-hib® (SLB), Hydrahib® (SLB) or Ultrahib® (SLB).

Finally, the polyol is a high molecular weight non-ionic polymer based on polyols. A person skilled in the art will recognize that the polyol applicable to the invention may be a commercial product, such as, for example, GEM-GP® (Halliburton), Aqua-col D® (Baker Hughes), Glydril MC® (SLB) or Deepdrill inhibitor® (NewPark).

The term “clay inhibitor”, as being used, refers to the components of the drilling fluid that have the function of preventing potential damage to the well caused by the hydration of clay particles generated during well drilling. The main clay inhibitors are inorganic salts, glycols, cationic polymers, amphoteric polymers, encapsulating polymers, and silicates. Encapsulating polymers and silicates are known to be the components with the greatest potential to cause damage to sandstone formations.

The solution being provided contemplates the depletion of encapsulating polymers and silicates at a predetermined distance from the top of the sandstone reservoir. Thus, the fluid begins drilling the well—clay phase—with a complete formulation and reaches the sandstone reservoir with a damage potential compatible with this formation, since the concentration of the encapsulating polymer and potassium silicate is expected to be negligible.

Determining the distance to the top of the sandstone reservoir where the encapsulating polymer and silicates will be depleted depends on the consumption of these components throughout the well drilling. As the drill bit advances through the shale section, clay particles detach from the rock and disperse in the fluid, interacting with inhibitors, which prevent the hydration of such particles and thus prevent clogging of the well under construction. Therefore, in the context of the invention, the expression “consumption of clay inhibitors” refers to the reduction of free clay inhibitor molecules in the drilling fluid as they interact with clay particles detached from the rock.

The consumption of clay inhibitors is a phenomenon intrinsic to well drilling. Therefore, as the drill bit advances through the shale, it is necessary to monitor the concentration of clay inhibitors as well as the content of clay particles dispersed in the fluid and, based on these factors, regularly replenish the clay inhibitors in the drilling fluid.

The evaluation of the drilling fluid composition during the activity can be carried out through a series of techniques known to those skilled in the art, see, for example, U.S. Ser. No. 10/871,762, U.S. Ser. No. 10/612,374, WO 2023107308 and US 20240329029.

In the context of the invention, the effectiveness of clay inhibitors in the drilling fluid is particularly measured through the recognized linear clay swelling technique (see, for example, WYSOCKI, Slawomir et al. Linear swelling test (LST) of clay formation under the influence of newly developed drilling fluids with the addition of cationic polymers. AGH Drilling, Oil, Gas, volume 32, number 4, pages 693 to 701, 2015), which indicates the desired parameter indirectly, i.e., by measuring the ability of the drilling fluid to inhibit clay hydration. Linear clay swelling values between 15 and 20% represent a satisfactory rock-fluid interaction.

Alternatively, in the field, visual inspection of a sample of cuttings taken from the shale section of the well being drilled is a representative indicator of the inhibitory capacity of the drilling fluid. Dry and intact cuttings indicate efficient chemical inhibition, demonstrating that the concentration of clay inhibitors is adequate. Wet and dispersed cuttings require an increase in the concentration or frequency of replenishment of clay inhibitors. Additionally, a tendency for plugging of the screens of the sieves, equipment for extracting solids from drilling fluids, signals deficient chemical inhibition.

The concentration of cationic polymers is measured by the semi-quantitative colorimetric method with a specific indicator from a previously prepared calibration curve.

The concentration of the encapsulating polymer is measured by acid-base titration after its hydrolysis, from a previously prepared calibration curve.

In addition, the amount of clay dispersed during drilling can be verified, for example, by the methylene blue test (MBT). It is known to those skilled in the art that the MBT demonstrates the cation exchange capacity of clay particles present in a drilling fluid—which is directly related to the amount of reactive/dispersed clays.

Higher MBT values mean a greater presence of expansive clays, which tend to swell and disperse upon contact with water. Generally, MBT values of 0 to 5 lb/bbl indicate stable fluid, with little swelling expected; between 5 and 15 lb/bbl suggest that preventive control with inhibitors may be necessary; from 15 to 25 lb/bbl are correlated with a significant tendency to disperse, with a high risk of instability; and above 25 lb/bbl represent a critical level, requiring immediate action (dilution, inhibition, solids control).

Tests of clay inhibitor concentration and dispersed clay content in drilling fluid are performed on samples collected at regular drilling intervals, which can be every approximately 25 m up to approximately 500 m drilled.

Based on the inhibition effectiveness tests and dispersed clay content in drilling fluid being described, a person skilled in the art is able to determine the clay inhibitor replenishment protocol appropriate to the formation being drilled.

Taken together, clay inhibitor concentration and clay content in drilling fluid indicate the potential for damage to the sandstone formation. The method of the present invention comprises the constant monitoring of such parameters for periodic replenishment of clay inhibitors in the drilling fluid throughout the shale section, with subsequent interruption of replenishment of the encapsulating polymer and silicate at a certain distance from the top of the sandstone reservoir.

The purpose achieved by the invention method is that the high-performance fluid approximates an inhibited drill-in fluid composition and is able to traverse the sandstone reservoir when its top is encountered. It is worth reinforcing that the other constituent inhibitors of the drilling fluid—cationic polymer and amphoteric polymer—follow the replenishment protocol to maintain the initial concentration of these components.

The determination of when to interrupt the replenishment protocol is based on the projected depth of the top of the sandstone reservoir and the extent of the shale section to be drilled in order to consume the clay inhibitors (e.g., encapsulating polymer and silicate) to a level where the potential for damage to the sandstone formation is acceptable. In general, a drilling fluid with a damage level to the sandstone formation of less than 60% is acceptable.

As demonstrated by the inventors, a high-performance drilling fluid will have the clay inhibitors consumed to an acceptable level for entry into the sandstone formation in a range of at least 10 m to at least 100 m from the top of the sandstone reservoir, which may be approximately 20 m, approximately 30 m, approximately 40 m, approximately 50 m, approximately 60 m, approximately 70 m, approximately 80 m, approximately 90 m, or approximately 100 m.

The method being described enables the drilling of production wells and, especially, injection wells in fields with significant stretches of clay formations followed by a sandstone reservoir using a single water-based drilling fluid. Thus, the use of the invention, particularly in post-salt layer fields, allows for a reduction in the number of well construction phases, the time spent on bottom completion installation operations and fluid changes, reduced use of chemicals, lower volume of drilling fluid, and better cementing quality.

The following examples are intended to be purely illustrative of the invention. They are presented in order to provide the person skilled in the art with a complete description of how the drilling method of the present invention can be performed. A person skilled in the art, in light of this disclosure, will recognize that many changes can be made to the specific embodiments disclosed and still obtain a similar or equivalent result without departing from the spirit and scope of the invention.

### EXAMPLES

### Example 1—Well Drilling with Inhibited Drilling Fluid

The formulations of the high-performance fluid, used to start drilling, and of an inhibited drilling fluid can be seen in Tables 1 and 2 below:

TABLE 1
High-performance fluid

| | | Concentration |
|---|---|---|
| Chemical product | Function | (lb/bbl) |
| Sodium chloride | Clay inhibitor | QSP |
| brine | | |
| Encapsulating | Clay inhibitor | 0.25 to 0.50 |
| polymer | | |
| Cationic polymer | Clay inhibitor | 5.0 |
| Amphoteric polymer | Clay inhibitor | 5.5 |
| Polyol | Clay inhibitor | 10.5 |
| Potassium silicate | Clay inhibitor | 10.5 |
| Potassium chloride | Clay inhibitor | 15.7 |
| HPA Starch | Filtrate reducer | 8.0 |
| Xanthan gum | Viscosifier | 1.5 |
| Sodium bicarbonate | Calcium | 0.5 |
| | precipitator | |
| Magnesium oxide | Alkalizing | 0.25 to 1.0 |
| Glutaraldehyde | Bactericida | 0.3 |
| Antifoaming agent | Antifoaming | 0.3 |
| Limestone 2-44 | Obturator | QSP |

TABLE 2
Drill-in inhibited fluid

| | | Concentration |
|---|---|---|
| Chemical product | Function | (lb/bbl) |
| Sodium chloride | Clay inhibitor | QSP |
| brine | | |
| Cationic polymer | Clay inhibitor | 5.0 |
| Amphoteric polymer | Clay inhibitor | 5.5 |
| Polyol | Clay inhibitor | 10.5 |
| Potassium chloride | Clay inhibitor | 15.7 |
| HPA Starch | Filtrate reducer | 8.0 |
| Xanthan gum | Viscosifier | 1.5 |
| Sodium bicarbonate | Calcium | 0.5 |
| | precipitator | |
| Magnesium oxide | Alkalizing | 0.25 to 1.0 |
| Glutaraldehyde | Bactericida | 0.3 |
| Antifoaming agent | Antifoaming | 0.3 |
| Limestone 2-44 | Obturator | QSP |

During the drilling of the entire section, the concentrations of clay inhibitors and the amount of clay dispersed in the drilling fluid are frequently monitored in order to allow for immediate replenishments based on the consumption rate and to ensure satisfactory chemical inhibition. Although the fluid program provides for periodic replenishment, this monitoring is essential, since more reactive clay formations may exhibit higher-than-expected consumption, and underestimated replenishment can lead to well problems associated with deficient chemical inhibition. Additionally, if the amount of clay dispersed in the fluid increases rapidly, it is possible to dilute the fluid in order to control this parameter.

A particular inhibitor replenishment protocol used in tests of the invention was as follows:
a) Encapsulating polymer—5.0 lb every 20 m;
b) Cationic polymer—100 L every 40 m;
c) Amphoteric polymer—100 L every 40 m;
d) Potassium silicate—100 L every 40 m;
e) Polyol—200 L every 40 m.

At 100 m from the planned depth to the top of the reservoir, the addition of the encapsulating polymer and potassium silicate is stopped. Considering that the high-performance fluid has a robust formulation with several clay inhibitors, it is understood that the remaining concentration of the encapsulating polymer and potassium silicate will be consumed during these final meters and that there will be no operational losses for the well construction during the drilling of the sandstone.

During the drilling of the sandstone reservoir, the concentrations of clay inhibitors and the clay content dispersed in the drilling fluid are also monitored, but with a slightly different focus. The clay inhibitors with low damage potential used in the formulation must maintain concentrations close to those used in the high-performance fluid, aiming to maintain the stability of the previously drilled shales, and the clay content needs to maintain values compatible with a low damage potential.

In order to validate the proposed method, some field tests were initially carried out in 2023 and 2024 using a more conservative strategy. The shale section was drilled using a high-performance fluid and, after open-hole fluid replacement, the sandstone reservoir was drilled with an inhibited drill-in fluid. This strategy had the following objectives and procedures:
1) Obtain a short-term solution for the design;
2) Evaluate the mechanical stability of the shale section after replacement with the inhibited drill-in fluid, attesting to the viability of the strategy;
3) Interrupt the addition of products with high potential for formation damage 80 m from the top of the sandstone, in order to deplete these materials to a concentration similar to that of a drill-in fluid;
4) Evaluate the increase in the dispersed clay content in the fluid during shale drilling. Values above 5.0 lb/bbl represent potential for formation damage;
5) Perform dilutions with 500 bbl of new fluid when the dispersed clay content reaches a value above 4.0 lb/bbl;
6) Collect fluid samples every 50 m in order to perform formation damage tests to assess the viability of introducing the fluid into the sandstone reservoir. Additionally, these samples allow establishing a curve of increasing clay content dispersed in the fluid during drilling and consequently evaluating from what extent the control of this parameter becomes critical and/or unfeasible.

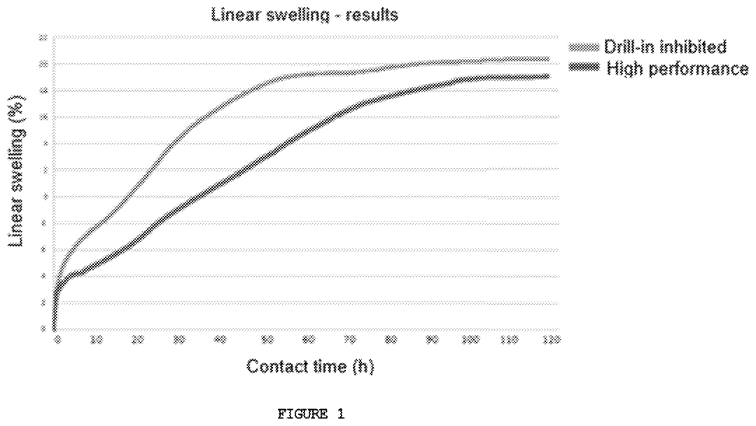

FIG. 1 shows the results of linear clay swelling tests of high-performance and drill-in inhibited fluids. These tests were performed on the FANN Linear Swell Meter (model 2100), with a reference of 15 to 20% for a satisfactory rock-fluid interaction.

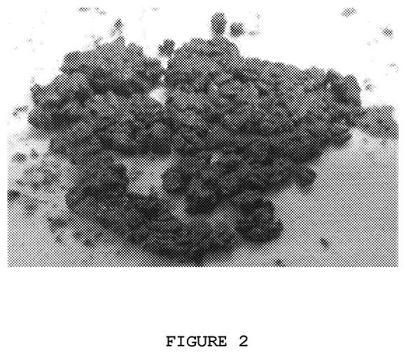

In FIG. 2, gravel from clay formations with a satisfactory appearance can be observed, showing that the high-performance fluid ensured sufficient chemical inhibition for the shale section.

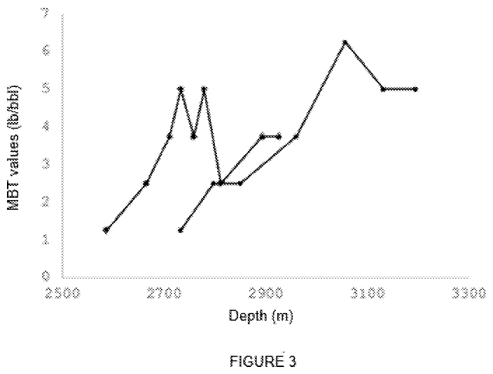

FIG. 3 shows curves of dispersed clay content during drilling of the phase, showing that it was possible to keep this parameter controlled with few dilutions during drilling of the clay section.

Tables 3 and 4 show formation damage test results for high-performance fluid samples at depths near the top of the sandstone compared with results from inhibited drill-in fluid. Formation damage values below 60% are considered satisfactory.

TABLE 3
Formation damage (field test - 2024)

| | | | | Characterization | | | | | | | | |
|---|---|---|---|---|---|---|---|---|---|---|---|---|
| Basic Petrophysics | | | | | | Visc. | Visc. | Results | | | | |
| | KN2 | Poros. | VP | | Weight | 30 °C | 65 °C | | | | Damage | Average |
| Code | (mD) | (%) | (cm³) | Fluid | (ppg) | (cP) | (cP) | Ki | Kf | Filtrate | % | damage |
| B-93 | 557.5 | 21.9 | 9.16 | High | 9.3 | 42 | 34 | 354.86 | 223.45 | 2.7 | 37.03 | 24.1 |
| | | | | performance | | | | | | | | |
| B-98 | 576.87 | 22.3 | 9.26 | High | | | | 219.94 | 195.28 | 2.7 | 11.21 | |
| | | | | performance | | | | | | | | |
| | | | | (duplicate) | | | | | | | | |
| B-94 | 595.1 | 22.1 | 9.22 | Inhibited | 9.3 | 32 | 25 | 216.56 | 175.9 | 2.2 | 18.78 | 22.4 |
| | | | | drill-in | | | | | | | | |
| B-103 | 627.73 | 22.5 | 9.39 | Inhibited | | | | 319.09 | 236.12 | 2.4 | 26.00 | |
| | | | | drill-in | | | | | | | | |
| | | | | (duplicate) | | | | | | | | |

TABLE 4
Formation damage (field test - 2024)

| | | | | Characterization | | | | | | | | |
|---|---|---|---|---|---|---|---|---|---|---|---|---|
| Basic Petrophysics | | | | | | Visc. | Visc. | Results | | | | |
| | KN2 | Poros. | VP | | Weight | 30 °C | 65 °C | | | | Damage | Average |
| Code | (mD) | (%) | (cm³) | Fluid | (ppg) | (cP) | (cP) | Ki | Kf | Filtrate | % | damage |
| B-99 | 505.73 | 21.5 | 8.4 | High | 9.2 | 34 | 35 | 130.78 | 85.2 | 3.2 | 34.85 | 37.0 |
| | | | | performance | | | | | | | | |
| B-101 | 476.15 | 21.1 | 8.39 | High | | | | 204.57 | 124.5 | 4.7 | 39.14 | |
| | | | | performance | | | | | | | | |
| | | | | (duplicate) | | | | | | | | |
| B-92 | 476.52 | 21.2 | 8.13 | Inhibited | 9.4 | 29 | 24 | 209.99 | 126.37 | 2.1 | 39.82 | 33.8 |
| | | | | drill-in | | | | | | | | |
| B-100 | 495.09 | 21.7 | 9.05 | Inhibited | | | | 245.93 | 177.68 | 1.9 | 27.75 | |
| | | | | drill-in | | | | | | | | |
| | | | | (duplicate) | | | | | | | | |

Field tests confirm the feasibility of continuing with the initial fluid without the need for a fluid change, thus minimizing the risk of damage to the sandstone reservoir. The operational parameters and tests performed with the collected samples confirmed the expected results, validating the decision to drill the phase with a single fluid and supporting the described drilling method.

What is claimed is:

1. A method for drilling a geological formation consisting of a shale section followed by a sandstone reservoir, comprising the use of a high-performance aqueous drilling fluid during drilling, further comprising:
a) periodically monitoring the concentration of clay inhibitors in the drilling fluid during drilling;
b) periodically monitoring the clay content dispersed in the drilling fluid during drilling; and
c) interrupting the replenishment of clay inhibitors in the drilling fluid at a predetermined distance from the sandstone reservoir.

2. The method according to claim 1, wherein the drilling fluid is a high-performance fluid composed of: sodium chloride brine, an encapsulating polymer, a cationic polymer, an amphoteric polymer, a polyol, potassium silicate, potassium chloride, HPA starch, xanthan gum, sodium bicarbonate, magnesium oxide, glutaraldehyde, antifoaming agent, and limestone 2-44.

3. The method according to claim 1, wherein:
the encapsulating polymer is a partially hydrolyzed polyacrylamide-based polymer of high molecular weight and anionic character;
the cationic polymer is a quaternary ammonium salt or polyelectrolyte based on low molecular weight polyamine;
the amphoteric polymer is a low molecular weight amphoteric polymer with an isoelectric point below 7.0; and
the polyol is a high molecular weight non-ionic polymer based on polyols.

4. The method according to claim 1, wherein samples of the drilling fluid are collected at regular intervals of about 25 m to about 500 m drilled.

5. The method according to claim 1, wherein the replenishment of clay inhibitors in the drilling fluid is interrupted at least 10 m, 20 m, 30 m, 40 m, 50 m, 60 m, 70 m, 80 m, 90 m, 100 m, 150 m, 200 m, 250 m or 300 m from the predicted depth to the top of the sandstone reservoir.

6. The method according to claim 1, wherein the replenishment of the encapsulating polymer and potassium silicate clay inhibitors in the drilling fluid is interrupted 100 m from the predicted depth to the top of the sandstone reservoir.
